(19) United States
(12) Patent Application Publication
(10) Pub. No.: US 2007/0235606 A1
(43) Pub. Date: Oct. 11, 2007

(54) DEVICE FOR HANGING OBJECTS ON A LADDER

(76) Inventor: Dennis M. Corson, Cedar Falls, IA (US)

Correspondence Address: ZARLEY LAW FIRM P.L.C., CAPITAL SQUARE, 400 LOCUST, SUITE 200, DES MOINES, IA, 50309-2350, US

(21) Appl. No.: 11/277,645

(22) Filed: Mar. 28, 2006

(51) Int. Cl. E06C 7/14

(52) U.S. Cl. 248/210

(57) ABSTRACT

A device for hanging objects from a ladder having an elongated member that fits within and extends through the hollow rung of a ladder. Slidably mounted to the elongated member are a pair of retainers that engage the support legs of the ladder. Protruding from the ends of the member are a pair of threaded stems. Threadably mounted on the stems are a pair of knobs.

### BACKGROUND OF THE INVENTION

This invention is directed toward a device for hanging objects on a ladder and more specifically a device which extends through the hollow rung of a ladder.

Ladders are well known in the art. Various devices have been designed to allow objects to be hung from the ladder such as buckets, caddies or trays, tools, and wire. These devices, however, can be cumbersome and get in the way of a user sometimes creating an unsafe environment. In addition, when hanging items supported by the upright rails of the ladder, the strength and stability of the ladder is diminished. Thus, a need exists in the art for a device that addresses these deficiencies.

An objective of this invention is to provide a device for hanging objects which does not diminish the strength or stability of a ladder.

Another objective of the present invention is to provide a device for hanging objects that does not interfere with one using a ladder.

A still further objective of this invention is to provide a device for hanging objects on a ladder that is not cumbersome to use.

These and other objectives will be apparent to those skilled in the art based on the following written description and claims.

### SUMMARY OF THE INVENTION

A device for hanging objects from a ladder having an elongated member that fits within and extends through the hollow rung of a ladder. Slidably mounted to the elongated member are a pair of retainers that engage the support legs of the ladder. Protruding from the ends of the member are a pair of threaded stems. Threadably mounted on the stems are a pair of knobs.

### BRIEF DESCRIPTION OF THE DRAWINGS

FIG. 1 is perspective view of a device for hanging objects from a ladder, and

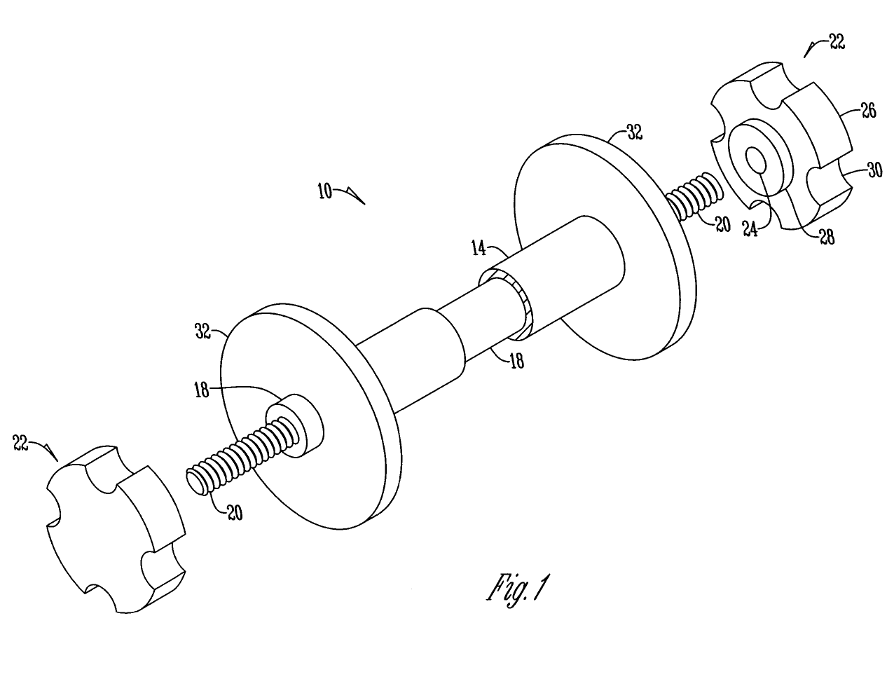

FIG. 2 is a side view of a device for hanging objects installed in a ladder.

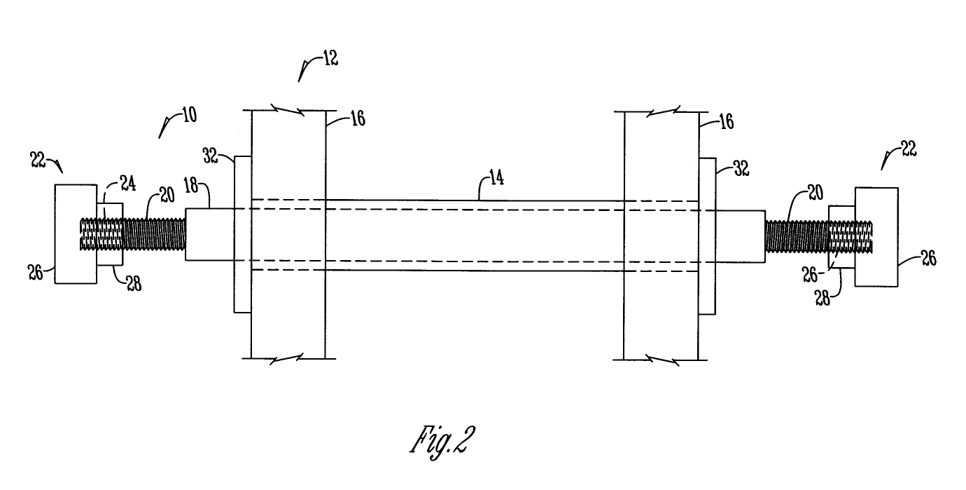

### DETAILED DESCRIPTION OF THE PREFERRED EMBODIMENT

Referring to the figures, the device 10 for hanging objects is used with any conventional ladder 12 having a plurality of rungs 14 that extend between support legs 16. The device has an elongated member 18 that has a diameter less than the hollow rung 14 of the ladder 12. The elongated member 18 is of any shape but preferably is cylindrical.

Protruding outwardly from the ends of the elongated member 18 are a pair of threaded stems 20. In combination with the elongated member 18, the length from the end of one stem 20 to the other is greater than the length of the hollow rung 14 such that when the elongated member 18 is placed in the rung 14, a portion of the member 18 and the stems 20 protrude beyond the support legs 16.

Threadably mounted to the stems 20 are a pair of knobs 22. The knobs have a threaded bore 24 that matingly receives the threaded stem 20. The knob 22 is of any shape and size but preferably has a generally cylindrical head 26 and a cylindrical body 28 extending outwardly from the head 26 and having a diameter less than the head 26. Additionally, the outer periphery of the head 26 of the knob 22 has a plurality of concave grooves 30 to allow for better gripping.

Frictionally and slidably mounted on the outer surface of the elongated member 18 are a pair of flexible retainers 32. The retainers 32 are of any shape and size but preferably extends radially outwardly from the elongated member 18.

In operation, the elongated member 18 is inserted into and through the hollow rung 14 of the ladder 12. The retainers 32 are slid over the ends of the elongated member 18 until they engage the support legs 16 of the ladder 12. The knobs 22 are then threadably attached to the stems 20. Objects, such as wire, may be held tightly between the body 28 of the knob 22 and the end of the elongated member 18 when the knob 22 is tightened. Alternatively, hooks and the like may be hung on the elongated member 18 between the retainer 32 and the knob 22.

Therefore, a device for hanging objects from a ladder has been shown that at least meets all the stated objectives.

What is claimed is:

1. A device for hanging objects from a ladder having hollow rungs extending between support legs, comprising:
an elongated member adapted to fit within the hollow rung, and
a pair of retainers slidably mounted to the elongated member and adapted to engage the support legs to hold the elongated member within the hollow rung.

2. The device of claim 1 wherein threaded stems protrude outwardly from ends of the elongated member.

3. The device of claim 2 wherein a pair of knobs threadably receive the stems.
